(19) United States
(12) Patent Application Publication
(10) Pub. No.: US 2011/0211684 A1
(43) Pub. Date: Sep. 1, 2011

(54) METHOD, DEVICE AND SYSTEM FOR JUDGING CALL TYPE

(75) Inventors: Yue Wu, Shenzhen (CN); Quan Yuan, Shenzhen (CN); Shaowei Zhang, Shenzhen (CN); Xuzu Shu, Shenzhen (CN); Guangbing Yan, Shenzhen (CN); Shiqiang Peng, Shenzhen (CN); Lingfei Ni, Shenzhen (CN)

(73) Assignee: Huawei Technologies Co., Ltd., Shenzhen (CN)

(21) Appl. No.: 13/093,297

(22) Filed: Apr. 25, 2011

Related U.S. Application Data
(63) Continuation of application No. PCT/CN2009/074593, filed on Oct. 23, 2009.

(30) Foreign Application Priority Data
Oct. 24, 2008 (CN) 200810170764.X
Jun. 30, 2009 (CN) 200910150738.5

(51) Int. Cl. H04M 3/42

(52) U.S. Cl. 379/201.02

(57) ABSTRACT

A method, device and system for judging a call type are disclosed in embodiments of the present invention. The method includes: receiving a call request from a calling terminal, where the call request carries a calling terminal number and a called terminal number; querying a number information storage server for plan information of the calling terminal number and/or the called terminal number according to the call request; and judging the call type of a call service corresponding to the call request according to the plan information of the calling terminal number and the called terminal number. In the embodiments of the present invention, a number information storage server stores and manages the number plan information uniformly, thus reducing the maintenance costs; and the method, device and system for judging a call type enable judging of the call type of a terminal.

### CROSS-REFERENCE TO RELATED APPLICATIONS

This application is a continuation of International Application No. PCT/CN2009/074593, filed on Oct. 23, 2009, which claims priority to Chinese Patent Application No. 200810170764.X, filed on Oct. 24, 2008 and Chinese Patent Application No. 200910150738.5, filed on Jun. 30, 2009, all of which are hereby incorporated by reference in their entireties.

### FIELD OF THE INVENTION

The present invention relates to the field of communication technologies, and in particular, to a method, device, and system for judging a call type.

### BACKGROUND OF THE INVENTION

The Federal Communications Commission (FCC) of America requires that the switches in charge of voice calls in North America should judge the call type. Call types include Local, Local Toll, Long Distance, and International. The switches in charge of voice calls in North America come in two types: Public Switched Telephone Network (PSTN) switch and Voice over Internet Protocol (VoIP) switch.

The North America Numbering Plan (NANP) involves massive data (hundreds of thousands of lines), which occupies enormous memory resources in the switches and results in a lot of retrievals.

The plan information of the calling number and the called number, namely, Local Access and Transport Area (LATA) and Rate Center (RC) information corresponding to the calling number and the called number, is essential for judging the call type. The FCC divides America (including Canada and Bermuda) into scores of LATAs, and each LATA governs scores of or even over a hundred RCs. Each number belongs to a specific RC.

For the purpose of judging the call type accurately, the switch queries for the LATA and the RC of the calling number and the called number respectively, and obtains the call type of the call according to a judgment logic. According to the FCC specifications, the first six digits of a number, namely, NPA-NXX of a North America number, can uniquely determine the LATA and the RC of the number. However, there are hundreds of thousands of NPA-NXXs.

The number and its LATA and RC are not constant. A special organization in North America publishes the latest data periodically in the form of Local Exchange Routing Guide (LERG) files, which are generally LERG6.DAT and LERGINS.DAT text files.

Accordingly, the data needs to be imported into every switch, and updated into the local database, which leads to high costs of maintenance.

What described above are only examples, and definitely regions are not limited to North America. In regions other than North America, the same problems occur in similar scenarios.

### SUMMARY OF THE INVENTION

Embodiments of the present invention provide a method, device and system for judging a call type. A number information storage server stores and manages the number plan information, thus reducing the maintenance costs; and the method, device and system for judging the call type enable judging of the call type of a terminal.

The objectives of the present invention are fulfilled through the following technical solution:

A method for judging a call type includes:

receiving a call request from a calling terminal, where the call request carries a calling terminal number and a called terminal number;

querying a number information storage server for plan information of the calling terminal number and/or the called terminal number according to the call request; and

judging a call type of a call service corresponding to the call request according to the plan information of the calling terminal number and the called terminal number.

A call control server includes:

a receiving module, configured to receive a call request from a calling terminal, where the call request carries a calling terminal number and a called terminal number;

a first querying module, configured to query a number information storage server for plan information and/or plan-related information of the calling terminal number and/or the called terminal number in the call request received by the receiving module; and

a judging module, configured to judge a call type of a call service corresponding to the call request, according to the plan information and/or plan-related information of the calling terminal number and the called terminal number, where the plan information and/or plan-related information is obtained by the first querying module.

A number information storage server includes:

a storing module, configured to store plan information and/or plan-related information of a number;

a receiving module, configured to receive a message for querying for plan information of a calling terminal number and/or a called terminal number;

a querying module, configured to: query the storing module for the plan information of the calling terminal number and/or the called terminal number, according to the message received by the receiving module; and/or query the storing module for plan-related information, according to the plan information of the calling terminal number and/or the called terminal number; and

a sending module, configured to: send the plan information of the calling terminal number and/or the called terminal number, and/or send the plan-related information, where the plan information and the plan-related information are obtained by the querying module.

A call control network includes:

a number information storage server, configured to store plan information and/or plan-related information of a number; and

a call control server, configured to: query the number information storage server for plan information of a calling terminal number and/or a called terminal number of a call service, and judge a call type of the call service according to the plan information and/or plan-related information.

The technical solution under the present invention brings these benefits: Because a number information storage server stores and manages the plan information and/or plan-related information of the number, it is not necessary for every call control server to store the relevant data, and the maintenance costs are reduced when the call type of the terminal is judged.

### BRIEF DESCRIPTION OF THE DRAWINGS

FIG. 1 is a schematic diagram of a flowchart of a method for judging a call type according to a first embodiment of the present invention;

FIG. 2 is a schematic diagram of a structure of a call control network according to a second embodiment of the present invention;

FIG. 3 is a schematic diagram of relations between LATAs and RCs according to an embodiment of the present invention;

FIG. 4 is schematic diagram of a flowchart of a method for judging a call type according to a third embodiment of the present invention;

FIG. 5 is a schematic diagram of a structure of a call control network for judging a call type in an IMS network according to an embodiment of the present invention;

FIG. 6 is a schematic diagram of a flowchart of a method for judging, by an S-CSCF, a call type according to a fourth embodiment of the present invention;

FIG. 7 is a schematic diagram of a flowchart of a method for judging, by an AS, a call type according to a fifth embodiment of the present invention;

FIG. 8 is a schematic diagram of a flowchart of a method for judging a call type according to a sixth embodiment of the present invention;

FIG. 9 is a schematic diagram of a flowchart of a method for judging a call type according to a seventh embodiment of the present invention;

FIG. 10 is a schematic diagram of a flowchart of a method for judging, by an I-CSCF/S-CSCF/AS, a call type according to an eighth embodiment of the present invention; and

FIG. 11 is a schematic diagram of a flowchart of a method for judging, by an HSS/HLR, a call type according to a ninth embodiment of the present invention.

### DETAILED DESCRIPTION OF THE EMBODIMENTS

The embodiments of the present invention are detailed below with reference to the accompanying drawings.

The inventor finds the following problems in the prior art: The number plan information needs to be imported and maintained in every call control device/switch; once the number plan information needs to be updated, every call control device/switch on the existing network needs to update the number plan information, which leads to high costs of maintenance and increases the probability of errors caused by asynchronous data on different call control devices/switches in the data update process; moreover, the size of the number plan information is enormous and generally there are hundreds of thousands of data entries, which need to be stored on every call control device/switch, thus wasting the storage space and increasing the hardware overhead of every call control device/switch.

In view of the problems in the prior art, embodiments of the present invention introduce a number information storage server to the existing communication network system to perform centralized storage and uniform management for the number plan information and/or plan-related information, thus reducing costs of hardware and maintenance. Further, embodiments of the present invention provide a method, device, and system for judging a call type by applying the number information storage server, so as to realize judging a call type of a terminal.

The technical solution under the present invention is expounded below with reference to embodiments and accompanying drawings. Evidently, the embodiments are exemplary only, without covering all embodiments of the present invention. All other embodiments, which can be derived by those skilled in the art from the embodiments given herein without creative efforts, shall fall within the protection scope of the present invention.

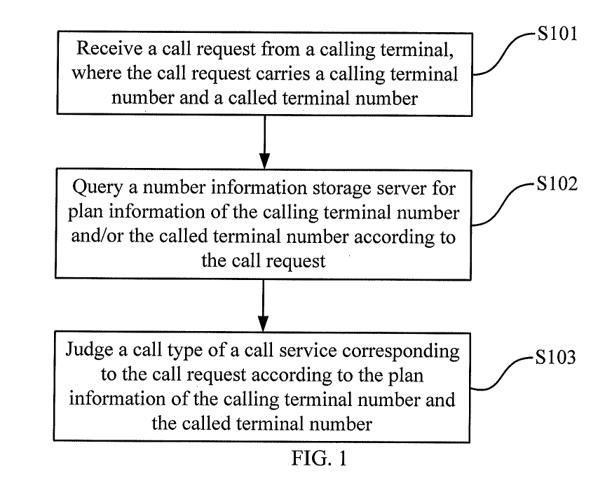

A method for judging the call type is provided in the first embodiment of the present invention. As shown in FIG. 1, the method includes the following steps:

Step S101: Receive a call request from a calling terminal, where the call request carries a calling terminal number and a called terminal number.

Step S102: Query a number information storage server for plan information of the calling terminal number and/or the called terminal number according to the call request.

This step may include the following detailed operations:

through a query interface, a query request that carries the calling terminal number is sent to the number information storage server, and a query response that carries the plan information of the calling terminal number is received from the number information storage server; and/or

through the query interface, a query request that carries the called terminal number is sent to the number information storage server, and a query response that carries the plan information of the called terminal number is received from the number information storage server.

It should be noted that, the plan information of the calling terminal number and the plan information of the called terminal number are generally queried and obtained in two attempts of query. In practical applications, to save network resources and reduce interactions, the query step may be simplified in the following two ways:

Scenario 1: When the calling terminal is registered, a call control server stores the plan information of the calling terminal number directly.

In this case, the query process in this step is modified as:

obtaining the locally stored plan information of the calling terminal number; and

querying and obtaining the number information storage server for the plan information of the called terminal number.

Obtaining the locally stored plan information of the calling terminal number is retrieving the information from the call control server directly, without the need of querying the number information storage server.

Scenario 2: After the plan information of the calling terminal number and the called terminal number is queried and obtained in step S102, the plan information of the calling terminal number and the called terminal number is stored directly. In this case, in the subsequent call setup process, the step of querying for the plan information in the process of judging the call type is modified as:

obtaining the locally stored plan information of the calling terminal number and querying the number information storage server for plan information of another called terminal number, when receiving a call request sent by the calling terminal to said another called terminal subsequently; or

obtaining the locally stored plan information of the called terminal number and querying the number information storage server for plan information of another calling terminal number, when receiving a call request sent by said another calling terminal to the called terminal subsequently; or

obtaining the locally stored plan information of the calling terminal number and the called terminal number, when receiving a call request sent by the calling terminal to the called terminal subsequently.

The variations of the solution above are put forward because in the basic solution of this step, an ordinary call relates to at least two attempts of querying for the plan information, which reduces the efficiency to some extent. Therefore, the embodiments of the present invention put forward an improved solution. A buffer of query records is introduced to reduce the times of querying for the plan information. Meanwhile, at the time of registration, the registered user information is retrieved from the number information storage server and stored. If the calling terminal and the called terminal communicate with a same call control server, the calls between the calling terminal and the called terminal involve no operation of querying the number information storage server.

Step S103: Judge a call type of a call service corresponding to the call request, according to the plan information of the calling terminal number and the called terminal number.

It should be noted that in the foregoing embodiment, the call control server judges the call type of the call service corresponding to the call request, according to the plan information of the calling terminal number and the called terminal number. In another embodiment of the present invention, the call control server may judge the call type of the call service corresponding to the call request, according to the plan information of the calling terminal number, the plan information of the called terminal number, and the plan-related information (Local RC). The plan-related information may be stored locally or stored in a number information storage server. When the plan-related information is stored in the number information storage server, the plan-related information can be queried from the number information storage server.

This step may include the following scenarios:

Scenario 1: A user plan-related request is sent to the number information storage server according to the plan information of the calling terminal number and the called terminal number; and the call type of the call service corresponding to the call request is judged according to a user plan-related response sent by the number information storage server.

Specifically, the plan-related information is stored in the number information storage server, and the call control server sends a user plan-related request to the number information storage server according to the plan information of the calling terminal number and the called terminal number; the number information storage server finds the plan-related information and sends a user plan-related response; and the call control server judges the call type of the call service corresponding to the call request according to the user plan-related response.

Scenario 2: A call request that carries the calling terminal number and the called terminal number is sent to the number information storage server, and the call type of the call service corresponding to the call request is received from the number information storage server.

Specifically, the call control server sends the call request that carries the calling terminal number and the called terminal number to the number information storage server, and the number information storage server finds the plan information of the calling terminal number and/or the called terminal number according to the call request. After obtaining the plan information of the calling terminal number and/or the called terminal number, the number information storage server may obtain the plan-related information according to the plan information. The number information storage server determines the call type according to the plan-related information, and returns a query result which carries the call type of the call service corresponding to the call request.

In practical applications, to save network resources and reduce interactions, the foregoing query step may be simplified in the following way:

Scenario 3: The plan information of the calling terminal number, the plan information of the called terminal number, and the plan-related information are stored directly after they are obtained. Therefore, in the subsequent call setup process, the query for the plan information of the calling terminal number, the plan information of the called terminal number, and the plan-related information can be simplified. For example, a buffer of query records is introduced to reduce the times of querying for the plan information and the plan-related information. Meanwhile, at the time of registration, the registered user information is retrieved from the number information storage server and stored into the call control server. If the calling terminal and the called terminal communicate with the same call control server, the calls between the calling terminal and the called terminal involve no operation of querying the number information storage server.

After completion of step S103, the method includes an update process, as detailed below:

When the calling terminal number and/or the called terminal number is updated, the call control server queries the number information storage server for the plan information corresponding to the updated calling terminal number and/or the called terminal number, and/or the plan-related information.

The call control server judges the call type of the call service corresponding to the call request, according to the plan information of the updated calling terminal number and called terminal number, and/or the plan-related information.

The number information storage server mentioned in this embodiment may be a single number information storage server, or a number information storage server pool including more than one number information storage server, which shall not be constructed as limitations to the protection scope of the present invention. The same is applicable throughout this document, and will not be repeated described hereinafter.

Further, depending on the application scenario, the preceding technical solution may be improved into the following two solutions:

Improved solution 1: In the number information storage server, the corresponding plan parameter such as routing number is configured for the special service number (such as North America N11 service).

N11 is a generic term of special numbers of North America, and is embodied as 211, 311, 411, 511, 611, 711, 811, and 911. In North America, such numbers bear special meanings. They are taken as examples here for ease of description. The details of the services of such special numbers are not further given here.

When the called terminal number is a preset service number, the call control server queries the number information storage server for the plan parameter corresponding to this service number. In the query process, the information that needs to be sent to the number information storage server carries the calling terminal number because such services usually relate to the location of the calling terminal number.

Taking the North America communication control network as an example, the process of implementing improved solution 1 is described below:

The LATA and RC information is stored into an E164 Telephone Number Mapping (ENUM) server together, and at the same time, the special service numbers such as N11 corresponding to the numbers are stored into the ENUM server together in the same way.

It should be noted that, in the North America communication control network, the ENUM server is the number information storage server in the embodiments mentioned above. The name of this server shall not be constructed as limitations to the protection scope of the present invention.

Taking the community service number 211 in North America as an example, when a user dials 211, the network translates 211 into a plan parameter, namely, a routable 10-digit North America Numbering Plan (NANP) number. The translation is based on the LATA and RC information corresponding to the calling terminal number. In the ideal circumstance, the RC region corresponding to the translated 10-digit NANP number is the same as the RC region corresponding to the calling terminal number. However, the two RC regions being the same or different shall not be constructed as limitations to the scope of the present invention. Further, the 10-digit NANP number is configured as a parameter into the Naming Authority Pointer (NAPTR) record corresponding to the calling terminal number, and therefore, the 10-digit NANP number is returned along with the ENUM response to the call control server, and the special service is implemented in the area where the calling user is located, or in a nearby area.

Improved solution 2: Planned domain names of the calling terminal number and the called terminal number are generated to judge the call type.

The detailed steps of this solution are as follows:

Generate planned domain names of the calling terminal number and the called terminal number according to the planned area names corresponding to the plan information of the calling terminal number and the called terminal number.

Check whether a Domain Name System (DNS) that stores a set of local call domain names includes the planned domain names of the calling terminal number and the called terminal number.

If the DNS includes the planned domain names, determine that the calling terminal number and the called terminal number are located in the same local calling area, and receive the local call type parameter generated by the DNS; if the DNS does not include the planned domain names, determine that the calling terminal number and the called terminal number are located in different local calling areas.

Still taking the North America communication control network as an example, the improved solution is as follows:

First, in a DNS, neighboring RCs are stored in the form of related domain names. For example, if RC1 is adjacent to RC2 and RC3, the DNS stores domain names “RC1.RC2” and “RC1.RC3”, and other neighboring RCs are processed in the same way.

The basis for the call control server to judge the call type of a call is not only the LATA and RC information published by the LERG but also the Local Calling Area information, which helps the call control server to judge whether the call is of the Local type or Local Toll type. However, the Local Calling Area information is not published along with the LERG data. Based on the technical conception herein, the call control server may make the RC names of the calling user and the called user into a domain name such as “RC1.RC2”, and query for the NAPTR record in the DNS that stores such related domain names.

If no record is found, it indicates that the RC of the calling user and the RC of the called user are in different local calling areas, namely, the call type of the call between the calling user and the called user is not “Local”; if the corresponding record is found, it indicates that the RC of the calling user and the RC of the called user are in the same local calling area, namely, the call type of the call between the calling user and the called user is “Local”.

After completion of the query, the DNS returns information to the call control server, where the information carries a parameter indicating whether the call type of the call between the calling user and the called user is “Local” or “Local Toll”.

It should be further noted that, the related domain name solution put forward in improved solution 2 is only a preferred embodiment of the present invention. Other methods with the same technical effect, for example, SRV records, are also covered in the protection scope of the present invention.

The technical solution in this embodiment brings these benefits: The number information storage server stores and manages the number plan information, and each call control server can query for the number plan information. Therefore, the number plan information is stored together and managed uniformly, which reduces the maintenance cost and saves the storage space and hardware resources.

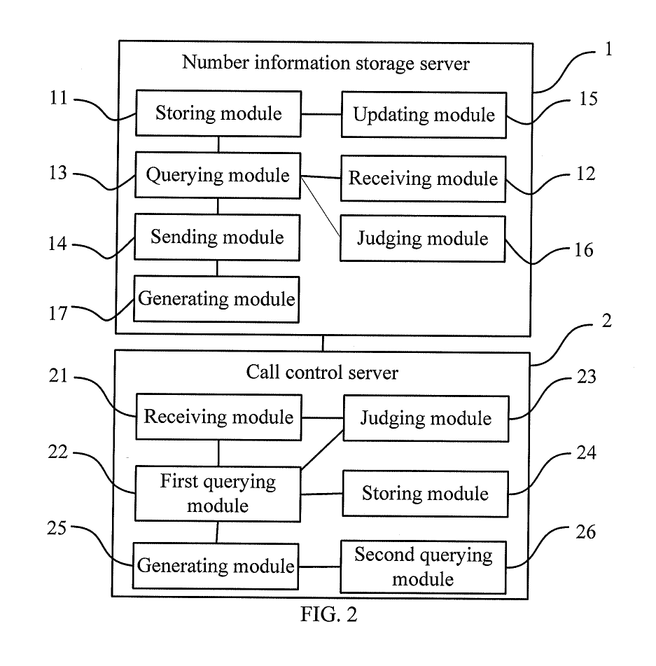

Corresponding to the method above, a call control network is provided in the second embodiment. As shown in FIG. 2, the call control network includes a number information storage server 1 and a call control server 2.

The number information storage server 1 is configured to: store plan information and/or plan-related information of a number, and further configured to update the plan information of the number according to routing update information. The number information storage server 1 includes:

a storing module 11, configured to store plan information and/or plan-related information of a number;

a receiving module 12, configured to receive a message from the call control server 2, where the message is for querying for plan information of a calling terminal number and/or a called terminal number;

a querying module 13, configured to: query the storing module 11 for the plan information of the calling terminal number and/or the called terminal number according to the message received by the receiving module 12; and/or query the storing module 11 for plan-related information according to the plan information of the calling terminal number and/or the called terminal number; and

a sending module 14, configured to: send the plan information of the calling terminal number and/or the called terminal number to the call control server 2, and/or send the plan-related information to the call control server 2, where the plan information and the plan-related information are obtained by the querying module 13.

Further, the number information storage server 1 includes:

an updating module 15, configured to update the number plan information stored in the storing module 11 according to a routing update guide file.

Taking the North America communication control network as an example, the routing update guide file is the latest data published by a special organization in North America periodically in the form of LERG text files, which are generally LERG6.DAT and LERGINS.DAT files. Other routing update guide files with the same technical effect are also covered in the protection scope of the present invention.

The querying module 13 in the number information storage server may query the storing module 11 for the plan information of the calling terminal number and/or called terminal number. After obtaining the plan information of the calling terminal number and/or called terminal number, the querying module 13 in the number information storage server may further query the storing module 11 for the plan-related information according to the plan information, and then the sending module sends the obtained information to the call control server 2.

Further, the number information storage server 1 may include a judging module 16, which is configured to judge the call type according to the plan-related information, whereupon the call type of the call service corresponding to the call request can be carried directly in the query result which is returned subsequently. The number information storage server 1 may further include:

a judging module 16, configured to judge the call type of the call service corresponding to the call request according to the plan information of the calling terminal number and/or called terminal number and plan-related information obtained by the querying module 13, whereupon the call type of the call service corresponding to the call request can be carried directly in the query result which is returned subsequently; and

a generating module 17, configured to generate a plan parameter of the called terminal number according to the plan information of the calling terminal number if the called terminal number is a preset service number, whereupon the sending module 14 sends the plan parameter of the called terminal number to the call control server 2.

The number information storage server 1 may be a single number information storage server, or a number information storage server pool including more than one number information storage server.

The call control server 2 is configured to: query the number information storage server 1 for plan information of a calling terminal number and/or a called terminal number of a call service, and judge a call type of the call service according to the plan information and/or plan-related information. The call control server 2 includes:

a receiving module 21, configured to receive a call request from a calling terminal, where the call request carries a calling terminal number and a called terminal number;

a first querying module 22, configured to query a number information storage server 2 for plan information of the calling terminal number and/or the called terminal number in the call request received by the receiving module 21, and/or plan-related information; and

a judging module 23, configured to judge a call type of a call service corresponding to the call request according to the plan-related information and/or the plan information of the calling terminal number and/or the called terminal number, where the plan information and/or plan-related information is obtained by the first querying module 22.

The call control server 2 further includes:

a storing module 24, configured to: store plan information of the calling terminal number at the time of registering the calling terminal; or store the plan information of the calling terminal number and/or the called terminal number, which is obtained by the first querying module 22.

Accordingly, the first querying module 22 is further configured to query the storing module 24 for the plan information of the calling terminal number and/or the called terminal number.

The call control server 2 further includes:

a generating module 25, configured to generate planned domain names of the calling terminal number and the called terminal number according to the planned area names corresponding to the plan information of the calling terminal number and the called terminal number, where the plan information is obtained by the first querying module 22; and

a second querying module 26, configured to check whether a DNS that stores a set of local call domain names includes the planned domain names of the calling terminal number and the called terminal number, where the planned domain names are generated by the generating module 25.

In a specific application scenario, the call control server 2 may be a Call Session Control Function (CSCF) entity and/or an Application Server (AS) in an IP Multimedia Subsystem (IMS), or a call control server in a softswitch network. Such variations are also covered in the protection scope of the present invention.

The foregoing modules may be distributed in one apparatus or more apparatuses. The foregoing modules may be combined into one module, or split into multiple submodules.

The technical solution in this embodiment brings these benefits: The number information storage server stores and manages the number plan information, and each call control server can query for the number plan information. Therefore, the number plan information is stored together and managed uniformly, which reduces the maintenance cost and saves the storage space and hardware resources.

The following embodiments expound the technical solution under the present invention, taking the North America communication control network as an example. The embodiments given herein are only preferred embodiments of the present invention, and other networks compliant with the requirements of the implementation scenario of this technical solution are also covered in the protection scope of the present invention. In the specific implementation scenarios, the names given herein shall not be constructed as limitations to the protection scope of the present invention.

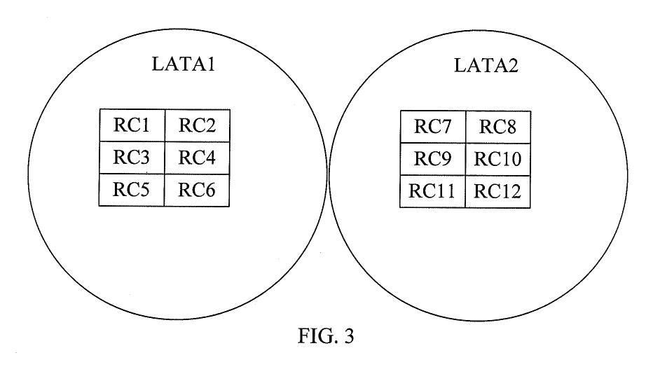

In the case of the North America communication control network, the technical solution under the present invention uses an ENUM server to store and manage the number plan information (LERG6 data), and provides a standard ENUM query interface for each call control server to perform centralized storage and uniform management for the number plan information. The number plan information includes LATA information and RC information. The relations between the LATA and the RC are as shown in FIG. 3.

Each call control server may query the ENUM server for the number plan information through a standard ENUM NAPTR. The calling terminal number and the called terminal number are input to the ENUM server through a standard ENUM query interface. The call control server queries for the matching NAPTR records on the ENUM server, and returns the number plan information such as LATA and RC corresponding to the number.

In the North America communication control network, the first six digits of the number, namely, NPA-NXX, can uniquely determine the LATA and RC information of the number. This embodiment takes two numbers as examples, whose first six digits are 612-201 and 207-698 respectively.

Two NAPTR records of 612-201 and 207-698 on the ENUM server are:
*.1.0.2.2.1.6 IN NA PTR 100 10 “u” “sip+E2U” “!̂(.*)$!sip:\\1;
napn_lata=628;napn_rc=TWINCITIES!”.
*.8.9.6.7.0.2 IN NA PTR 100 10 “u” “sip+E2U” “!̂(.*)$!sip:\\1;
napn_lata=120;napn_rc=BERWICK!”.

As shown above, the number with the initial “612-201” is mapped to a Sip URI through the NAPTR record. The Sip URI includes the parameters that carry LATA and RC information. The LATA information is a 3-digit identifier “628”; and the RC information is an identification character composed of up to 10 digits. The RC information of the number with the initial “612-201” is composed up of 10 digits, namely, TWINCITIES.

In this way, when the call control server queries for the ENUM by using the 612-201-XXXX number, such parameters serve as the plan information of the number, and are returned along with the query response to the call control server.

Likewise, the number with the initial “207-698” is mapped to a Sip URI through the NAPTR record. The Sip URI includes the parameters that carry LATA and RC information. The LATA information is a 3-digit identifier “120”; and the RC information is an identification character composed of up to 10 digits. The RC information of the number with the initial “207-698” is composed up of 7 digits, namely, BERWICK.

To avoid confusion with other ENUM query, a separate top level domain may be defined. For ease of description herein, “e164.arpa” is taken as an example of the top level domain.

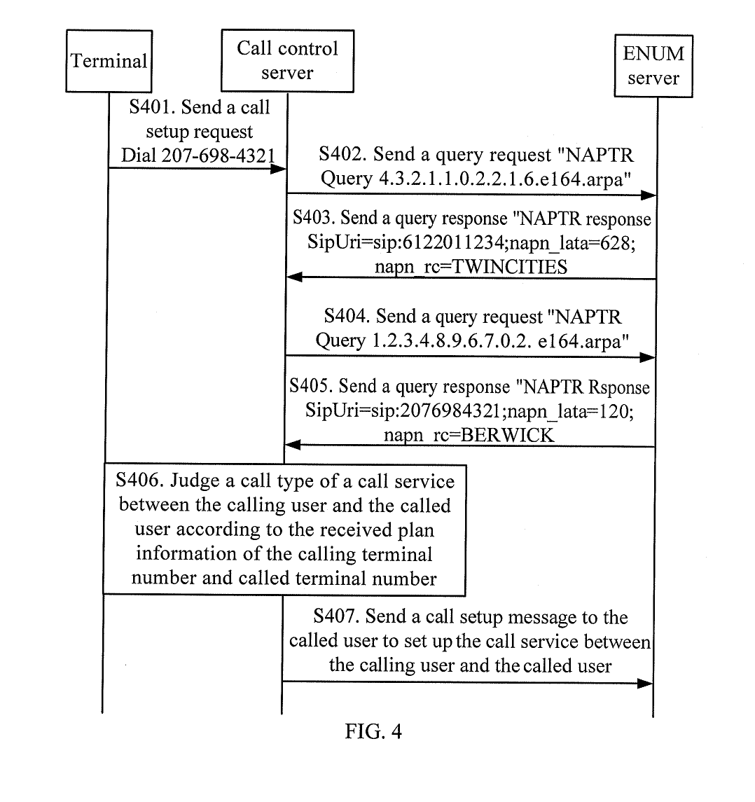

Based on the foregoing rule settings, the third embodiment of the present invention gives a detailed process of implementing the technical solution, supposing that the calling user 612-201-1234 originates a call to the called user 207-698-4321. As shown in FIG. 4, the process includes the following steps:

Step S401: The calling terminal sends a call setup request that carries the calling terminal number and the called terminal number to the call control server.

Step S402: The call control server sends a query request to the ENUM server, requesting to query for the plan information of the calling terminal number.

That is, the call control server sends an NAPTR query message that carries the E164 number “612-201-1234” of the calling user, requesting to query for the plan information of this number.

In the technical solution under the present invention, the call control server queries the ENUM server through a standard ENUM interface. Therefore, at the time of sending the calling terminal number and the called terminal number to the ENUM server, the existing E164 number is translated into the DNS domain name compliant with the standard ENUM interface before the number is transmitted. For example, the E164 number “612-201-1234” is mapped to the DNS domain name “4.3.2.1.1.0.2.2.1.6.e164.arpa”, where “e164.arpa” is a top level domain designed for the ENUM server to identify the information.

Therefore, the details of step S402 are: The call control server sends a query message through the standard ENUM interface. The query message carries a DNS domain name “4.3.2.1.1.0.2.2.1.6.e164.arpa”, and requests to query for the corresponding plan information.

The same is applicable throughout this document, and will not be repeatedly described in the subsequent embodiments.

Step S403: The ENUM server sends a query response to the call control server. The query response carries the plan information of the calling terminal number.

That is, the ENUM server sends an NAPTR response that carries the plan information of the calling terminal number to the call control server. The plan information includes LATA information and RC information.

Step S404: The call control server sends a query request to the ENUM server, requesting to query for the plan information of the called terminal number.

That is, the call control server sends a query message through the standard ENUM interface. The query message carries a DNS domain name “1.2.3.4.8. 9.6.7.0.2.e164.arpa”, and requests to query for the corresponding plan information.

Step S405: The ENUM server sends a query response to the call control server. The query response carries the plan information of the called terminal number.

That is, the ENUM server sends an NAPTR response that carries the plan information of the called terminal number to the call control server. The plan information includes LATA information and RC information.

Step S402 and step S403 complete the process of querying for the plan information of the calling terminal number; step S404 and step S405 complete the process of querying for the plan information of the called terminal number. However, the process of querying for the plan information of the calling terminal number may occur before, during or after the process of querying for the plan information of the called terminal number. The change of the sequence of such steps shall not be constructed as limitations to the protection scope of the present invention.

Step S406: The call control server judges the call type of the call service between the calling user and the called user according to the received plan information of the calling terminal number and called terminal number.

The judgment rules are described below:

As shown in FIG. 3 that illustrates the relation between the LATA and the RC, supposing that number A in LATA1 belongs to RC1, if a call is originated from this number to a number in LATA2, the call type of the call is InterLATA, namely, a call between different LATAs; if a call is originated from number A to a number in RC6 in LATA1, because both the calling number and the called number belong to LATA1, the call type of the call is IntraLATA, namely, a call in the same LATA; if a call is originated from number A to a number in RC1, because the calling number and the called number belong to the same RC, the call type of the call is Local.

Step S407: The call control server sends a call setup message to the called user to set up a call service between the calling user and the called user.

In this embodiment, the call control server obtains the LATA and RC information of the calling number and the called number through two attempts of NAPTR query, and determines the call type of the call through the local judgment logic. In this way, the call type is determined without the need of storing masses of data locally.

Specifically, the technical solution in the third embodiment of the present invention may be implemented in an IMS network, where the call control server is a CSCF. The CSCF queries the ENUM server for the plan information of the calling terminal number and the called terminal number through a standard ENUM query interface, and determines the call type of the call service according to the obtained plan information.

In the IMS network, because the call control is separated from the service, the AS needs to obtain LATA and RC information of the user through the ENUM query interface in certain scenarios.

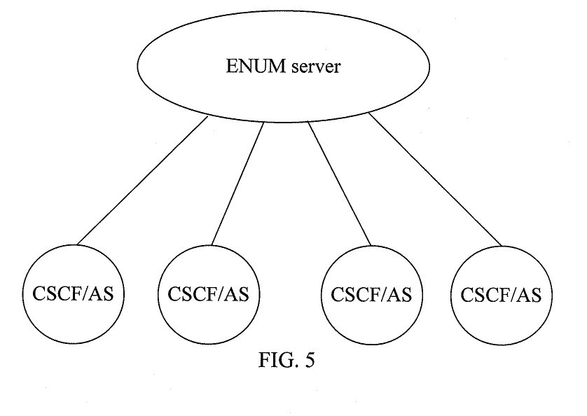

FIG. 5 shows a schematic diagram of a structure of a call control network in an IMS network based on the technical solution in this embodiment.

As shown in FIG. 5, the number plan information is stored in a centralized way in this networking architecture so that the data can be maintained and updated conveniently; moreover, a standard ENUM interface is applied between the CSCF/AS and the ENUM, without involving any extension, and therefore, the modification of the existing network is minimized, and the cost is controlled efficiently.

Because the data is stored in a centralized way in this networking architecture, to provide higher reliability, the ENUM server may be deployed in the form of a resource pool to implement load sharing and disaster recovery.

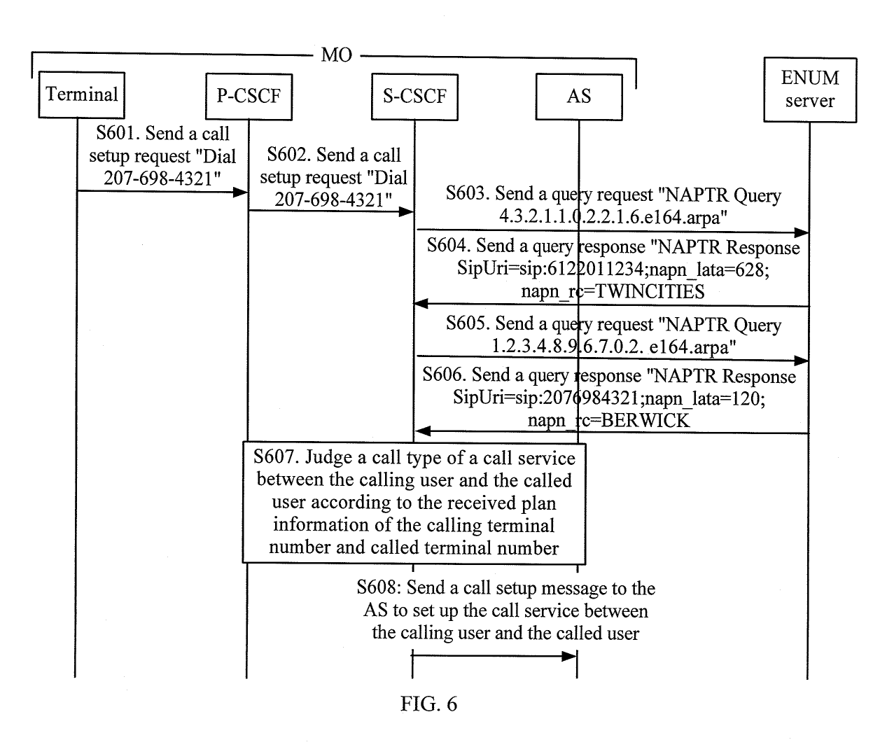

The fourth embodiment deals with the method for a CSCF to judge the call type in an IMS network. FIG. 6 shows a schematic diagram of a flowchart of a method for querying, by a CSCF, an ENUM server in an IMS network.

In this embodiment, it is still assumed that the calling user 612-201-1234 originates a call to the called user 207-698-4321. The method includes the following steps:

Step S601: The terminal sends a call setup request that carries the calling terminal number and the called terminal number to a Proxy CSCF (P-CSCF).

Step S602: The P-CSCF forwards the call setup request that carries the calling terminal number and the called terminal number to a Serving CSCF (S-CSCF).

Step S603: The S-CSCF sends a query request to an ENUM server, requesting to query for the plan information of the calling terminal number.

That is, the S-CSCF sends a query message through a standard ENUM interface. The query message carries a DNS domain name “4.3.2.1.1.0.2.2.1.6. e164.arpa”, and requests to query for the corresponding plan information.

Step S604: The ENUM server sends a query response that carries the plan information of the calling terminal number to the S-CSCF.

That is, the ENUM server sends an NAPTR response that carries the plan information of the calling terminal number to the S-CSCF. The plan information includes LATA information and RC information.

Step S605: The S-CSCF sends a query request to an ENUM server, requesting to query for the plan information of the called terminal number.

That is, the S-CSCF sends a query message through a standard ENUM interface. The query message carries a DNS domain name “1.2.3.4.8.9.6.7.0.2. e164.arpa”, and requests to query for the corresponding plan information.

Step S606: The ENUM server sends a query response that carries the plan information of the called terminal number to the S-CSCF.

That is, the ENUM server sends an NAPTR response that carries the plan information of the called terminal number to the S-CSCF. The plan information includes LATA information and RC information.

Step S607: The S-CSCF judges the call type of the call service between the calling user and the called user according to the received plan information of the calling terminal number and called terminal number.

Step S608: The S-CSCF sends a call setup message to the AS to set up the call service between the calling user and the called user.

In this embodiment, the call control server obtains the LATA and RC information of the calling number and the called number through two attempts of NAPTR query, and determines the call type of the call through the local judgment logic. In this way, the call type is determined without the need of storing masses of data locally.

Specifically, in this call process, the calling CSCF needs to query the ENUM server for the calling terminal number and the called terminal number respectively to obtain the LATA and RC information of the calling terminal number and the called terminal number, and then determine the call type of this call through the local judgment logic.

In certain services, the judgment and the subsequent service cannot go on unless the call type is known. For example, the service needs to restrict the calls of a certain call type. In this case, the CSCF needs to send the determined call type to the AS in a certain way before triggering the operation on the AS. Specifically, the call type may be carried in a parameter of a certain format in a Session Initiation Protocol (SIP) message. When the service of the AS involves modification of the calling terminal number or called terminal number, after the operation is triggered on the AS and delivered to the CSCF, the CSCF still needs to judge the call type again.

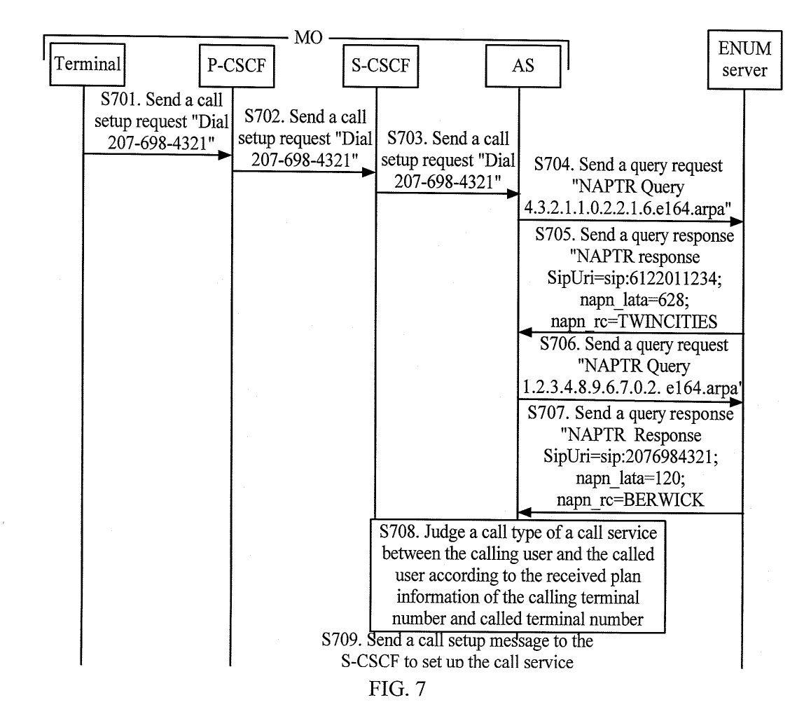

Due to the impact of the service, an alternative practice is: The AS judges the call type instead. In this case, the ENUM query occurs on the AS, which is detailed in the fifth embodiment. As shown in FIG. 7, the fifth embodiment includes the following steps:

Step S701: The terminal sends a call setup request that carries the calling terminal number and the called terminal number to a P-CSCF.

Step S702: The P-CSCF forwards the call setup request that carries the calling terminal number and the called terminal number to an S-CSCF.

Step S703: The S-CSCF forwards the call setup request that carries the calling terminal number and the called terminal number to an AS.

Step S704: The AS sends a query request to an ENUM server, requesting to query for the plan information of the calling terminal number.

That is, the AS sends a query message through a standard ENUM interface. The query message carries a DNS domain name “4.3.2.1.1.0.2.2.1.6. e164.arpa”, and requests to query for the corresponding plan information.

Step S705: The ENUM server sends a query response that carries the plan information of the calling terminal number to the AS.

That is, the ENUM server sends an NAPTR response that carries the plan information of the calling terminal number to the AS. The plan information includes LATA information and RC information.

Step S706: The AS sends a query request to an ENUM server, requesting to query for the plan information of the called terminal number.

That is, the AS sends a query message through a standard ENUM interface. The query message carries a DNS domain name “1.2.3.4.8.9.6.7.0.2. e164.arpa”, and requests to query for the corresponding plan information.

Step S707: The ENUM server sends a query response that carries the plan information of the called terminal number to the AS.

That is, the ENUM server sends an NAPTR response that carries the plan information of the called terminal number to the AS. The plan information includes LATA information and RC information.

Step S708: The AS judges a call type of a call service between the calling user and the called user according to the received plan information of the calling terminal number and called terminal number.

Step S709: The AS sends the call setup message to the S-CSCF. The S-CSCF performs subsequent operations to set up the call service between the calling user and the called user.

Through the foregoing technical solution, the AS needs to query the ENUM server as long as the service imposes an impact on the call type.

Further, in certain application scenarios, both the CSCF and the AS need to query the ENUM server and judge the call type to ensure data accuracy. In this case, the technical solution is similar, and is not further described here. Such variations of the technical solution are also covered in the protection scope of the present invention.

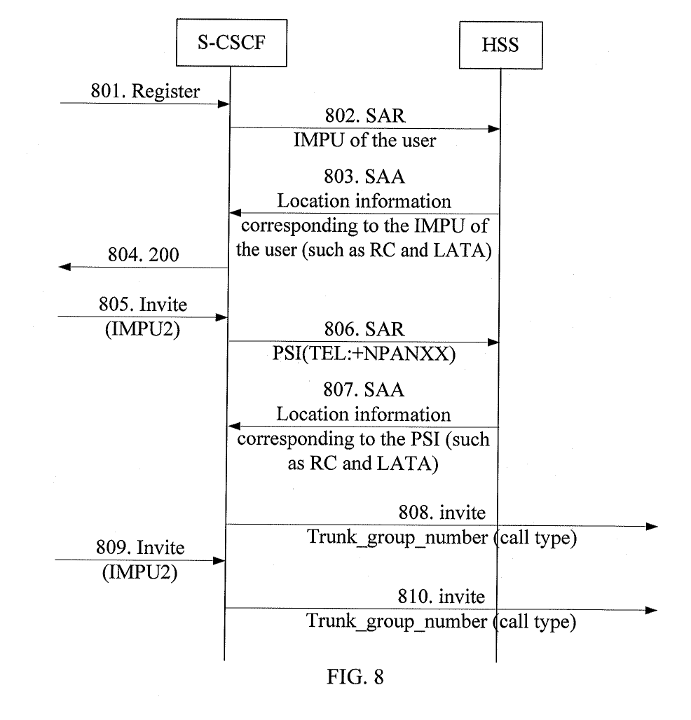

In the sixth embodiment of the present invention, the plan information is stored in a number information storage server such as a Home Subscriber Server (HSS) or a Home Location Register (HLR) in a centralized way, and a call control server (S-CSCF/I-CSCF/AS) or a number information storage server (HSS/HLR) judges the call type. The following describes the process of judging the call type with reference to FIG. 8.

Step 801: The S-CSCF receives a user registration message, and sends a Server-Assignment-Request (SAR) to download the user subscription data.

It should be noted that, if the user is not registered, or if no plan information of the user exists in the locally registered user data, the S-CSCF may use the NPA-NXX of the calling number to query the HSS first and obtain the plan information of the calling user.

Step 802: After receiving the user subscription data from the S-CSCF, the HSS downloads the plan information (RC, LATA) of the user from a Server-Assignment-Answer (SAA) in a group AVP format.

Step 803: After receiving the plan information from the HSS, the S-CSCF saves the plan information locally.

Step 804: The S-CSCF returns a 200 response.

Step 805: After receiving an Invite request, the S-CSCF extracts the called number from the Request-URI and regulates the number.

Step 806: The S-CSCF finds that the Invite request carries no Call Type information, and uses the NPA-NXX in the calling number and the NPA-NXX in the called number to query the local configuration first. If the call type can be obtained in the local configuration, it is not necessary to query for the plan information of the called number; if the call type cannot be obtained in the local configuration, the S-CSCF uses the NPA-NXX in the called number to construct a Public Service Identities (PSI) of the TEL format, and then sends an SAR to the HSS to obtain the plan information.

Step 807: After receiving the SAR, the HSS performs precise matching to obtain plan information of the PSI according to the PSI, and returns the plan information to the S-CSCF in a group AVP format.

Step 808: The S-CSCF judges the call type according to the plan information (RC and LATA data) of the calling number and called number and the plan-related information (Local RC) stored locally, and obtains the call type and carries it in a “trunk group” parameter in the request. The S-CSCF saves the NPA-NXX in the calling number, the NPA-NXX in the called number, and the corresponding call type locally.

After completion of this call, if the user dials the called number again, the process proceeds to the following steps:

Step 809: After receiving an initial Invite request, the S-CSCF extracts the NPA-NXX from the calling number and the called number, and queries the local configuration to obtain the call type.

Step 810: The S-CSCF sends a request that carries the call type.

In this case, because the S-CSCF has stored the call type corresponding to the call between the specific calling number and called number, the call type is obtained locally for this initial call request, without the need of querying the HSS.

To prevent seldom used redundant data from occupying the HSS/HLR memory space, the stored plan information complies with a certain storage period and aging mechanism. For example, the storage period may be the maximum registration duration supported by the system.

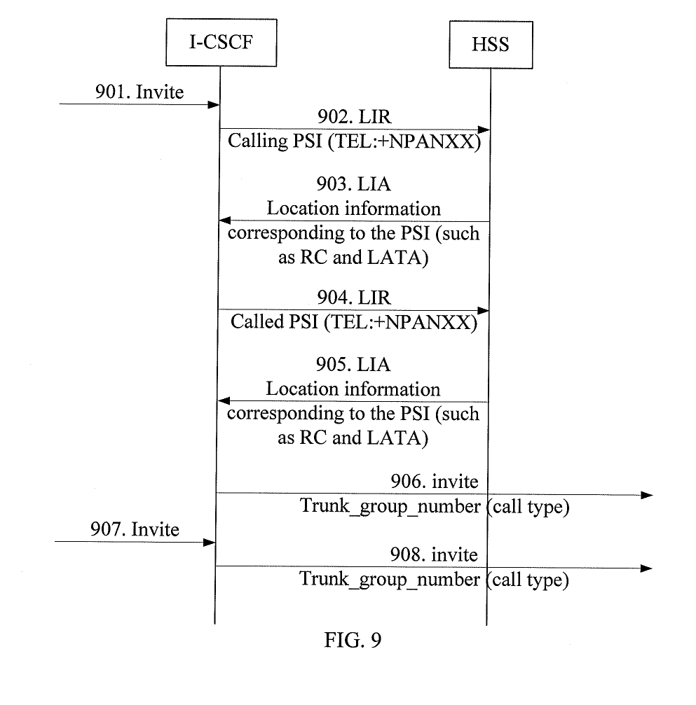

FIG. 9 shows a process for judging a call type according to the seventh embodiment of the present invention. As shown in FIG. 9, the process of judging the call type includes the following steps:

Step 901: After receiving an Invite request, an Interrogating CSCF (I-CSCF) extracts the called number from the Request-URI and regulates the number.

Step 902: The I-CSCF finds that the request carries no call type information, and uses the NPA-NXX in the calling number and the NPA-NXX in the called number to query the local configuration first. If no call type is obtained from the local configuration, the I-CSCF uses the NPA-NXX in the calling number to construct a PSI of the TEL format, and sends a Location-Info-Request (LIR) to download the user data.

Step 903: After receiving the LIR, the HSS performs precise matching to obtain plan information of the PSI according to the PSI, and returns a Location-Info-Answer (LIA) to the I-CSCF in a group AVP format.

Step 904: After receiving the LIA, the I-CSCF obtains the plan information of the calling number and stores the information locally, and uses the NPA and NXX in the called number to construct a PSI of the TEL format, and sends an LIR to download the user data.

Step 905: After receiving the LIR, according to the PSI the HSS performs precise matching to obtain plan information corresponding to the PSI, and returns a LIA to the I-CSCF in a group AVP format.

Step 906: After receiving the LIA, the I-CSCF obtains the plan information of the calling number and stores it locally. The I-CSCF judges the call type according to the obtained plan information (RC and LATA data) of the calling number and called number and the plan-related information (Local RC), and obtains the call type and carries it in the request. The I-CSCF saves the NPA-NXX in the calling number, the NPA-NXX in the called number, and the corresponding call type locally.

Step 907: After receiving an initial Invite request, the I-CSCF extracts the NPA-NXX from the calling number and the called number, and queries the local configuration to obtain the call type.

Step 908: The I-CSCF sends a request that carries the call type.

In the foregoing embodiment, the plan information of the calling number and the plan information of the called number may be downloaded from the HSS together.

The scenario where an AS stores the location-related information (Local RC) locally is similar to the sixth embodiment and the seventh embodiment described above. The HSS/HLR stores the LATA data and RC data, and the AS uses a PSI to download LATA and RC data through an SH interface. If an AS that supports the third-party registration and provides services is registered with a third party, the plan information (RC, LATA) of the user is downloaded from the HSS/HLR through an SH interface according to the IMS Public User Identity (IMPU). The subsequent process is similar to the process that the S-CSCF or I-CSCF obtains the call type.

In the process of judging the call type in the sixth and seventh embodiments, the Local RC data is stored locally; the S-CSCF/I-CSCF judges the call type of the call according to the calling/called number plan information (RC, LATA) obtained from the HSS and the local RC data stored locally. In another embodiment, the LATA data, the RC data, and the Local RC data are stored in an HSS, and an I-CSCF/S-CSCF/AS judges the call type, as detailed below.

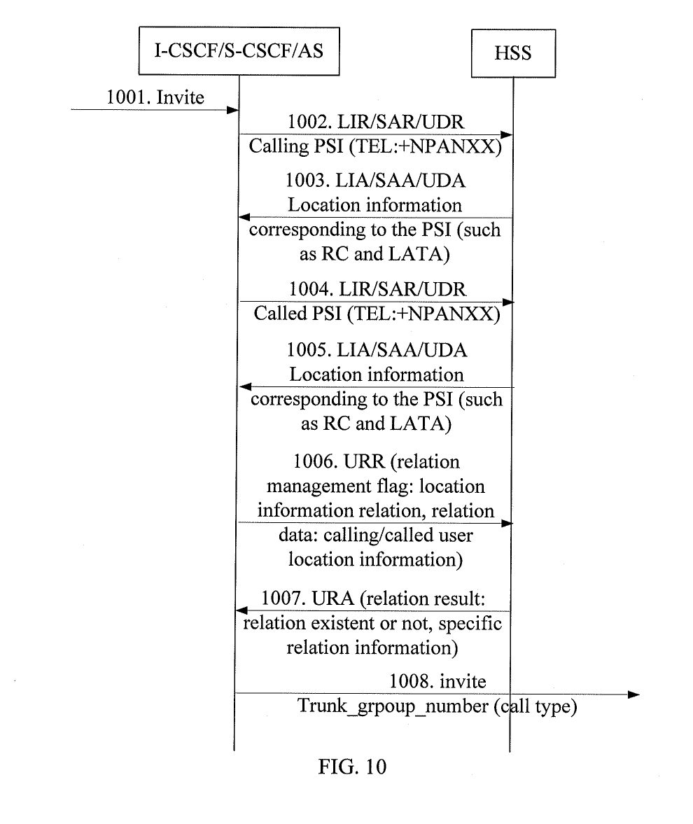

FIG. 10 shows how an I-CSCF/S-CSCF/AS judges a call type according to the eighth embodiment of the present invention. The process includes the following steps:

Steps 1001-1005: After receiving an Invite request, the plan information of the calling number and the called number is obtained through an interaction with the HSS. The process is similar to the previous embodiment, and is not repeatedly described.

Step 1006: The call control server (I-CSCF/S-CSCF) or AS sends a User-Relation-Request (URR) to the HSS according to the obtained calling/called number plan information. The request carries a relation type flag (such as a location relation).

More specifically, the plan-related information (Local RC) of the user is stored on the HSS/HLR. After receiving a request for querying for the user relation information from the call control server (I-CSCF/S-CSCF) or AS, the HSS queries for the user relation information (Local RC).

Step 1007: After receiving a location relation response from the HSS, the call control server (I-CSCF/S-CSCF) or AS judges the call type of the call according to the relation result, namely, plan-related information.

If the relation result is empty or null, it is not necessary to change the local call type; if the relation result shows existence of a relation, the local call type needs to be replaced with the specific relation information.

Step 1008: The call control server (I-CSCF/S-CSCF) or AS sends a request that carries the call type.

This embodiment differs from the sixth embodiment and the seventh embodiment in that: All plan information and plan-related information are stored on the HSS/HLR in a centralized way, thus reducing the data redundancy and improving the data reliability; and the call type is still judged by the call control server (I-CSCF/S-CSCF) or AS, and the HSS/HLR only stores and manages data, not involving service logics.

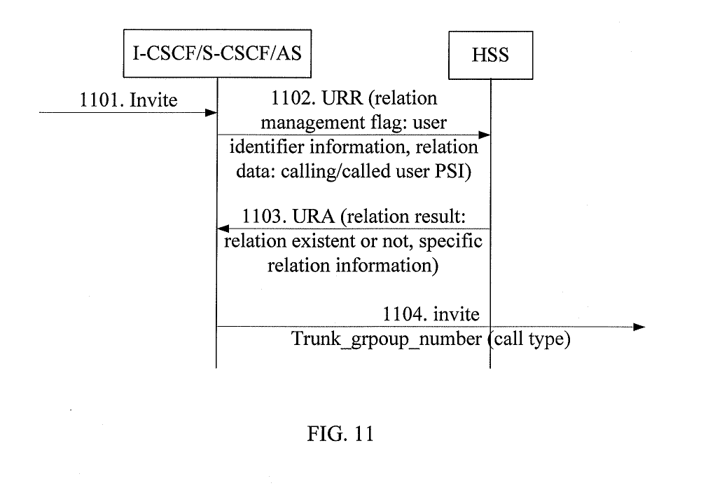

In another embodiment of the present invention, the plan information and the Local RC information are stored on the HSS/HLR, and the HSS/HLR judges the call type. In this case, the call type of a call is obtained through only one interaction, thus improving the efficiency of the whole call control network. This implementation mode is described below with reference to the ninth embodiment and FIG. 11.

As shown in FIG. 11, the HSS/HLR judges the call type in the following way:

Step 1101: After receiving an initial Invite request, the I-CSCF/S-CSCF/AS finds that no call type is carried in the request, uses NPA NXX in the calling number and the called number to construct a calling/called PSI in a User-Relation-Request (URR), and inputs user identifier information as a relation management flag.

Step 1102: The I-CSCF/S-CSCF/AS sends the URR to the HSS.

Step 1103: The HSS queries the corresponding subscription data according to the calling/called PSI to obtain the plan information of the calling number and the called number and the plan-related information; judges the call type according to the plan information of the calling number and the called number and the plan-related information, and obtains the call type information. The HSS inputs the call type information into the specific relation information in a User-Relation-Answer (URA), and returns the response to the I-CSCF/S-CSCF/AS.

Step 1104: Because the relation result indicates existence of a relation, the I-CSCF/S-CSCF/AS extracts the call type from the detailed relation information, and carries it in an Invite request to be sent.

In the technical solution in this embodiment, an HSS/HLR or an ENUM server in the IMS/ Next Generation Network (NGN) architecture stores the data in a centralized way, namely, stores LATA data, RC data, and/or Local RC data together so that the user data is managed uniformly; and a call control server or an HSS/HLR judges the call type according to the LATA and RC, and/or Local RC, thus saving the memory of the call control device/switch massively, reducing the interactions in the process of judging the call type, and improving the efficiency and reliability of data storage.

Although this embodiment describes the technical solution implemented in an IMS network, the technical solution may be implemented in a softswitch network as well. That is, the softswitch call control server queries the ENUM server, or upgraded HLR, or HSS/HLR, and judges the call type of the call according to the query result. The query process is the similar to that described in the preceding embodiments, and is not further described here.

The technical solution in this embodiment brings these benefits: The number information storage server such as the ENUM server, or HSS/HLR stores and manages the number plan information, and each call control server can query for the number plan information. Therefore, the number plan information is stored together and managed uniformly, which reduces the maintenance cost and saves the storage space and hardware resources.

Moreover, a method, device, and system for judging a call type by applying the number information storage server are provided herein to facilitate the terminal to judge the call type.

After reading the foregoing embodiments, those skilled in the art are clearly aware that the present invention may be implemented through hardware, or through software in addition to a necessary universal hardware platform. The technical solution under the present invention may be embodied as a software product. The software product may be stored in a computer-readable storage medium (such as a CD-ROM, a USB flash disk, or a mobile hard disk), and may include several instructions that enable a computer device (such as a personal computer, a server, or a network device) to perform the methods specified in any embodiment of the present invention.

The above descriptions are merely some exemplary embodiments of the present invention, but not intended to limit the scope of the present invention. Any modifications, variations or replacement that can be easily derived by those skilled in the art should fall within the scope of the present invention. Therefore, the scope of the present invention is subject to the appended claims.

What is claimed is:

1. A method for judging a call type, comprising:
receiving a call request from a calling terminal, wherein the call request carries a calling terminal number and a called terminal number;
querying a number information storage server for plan information of at least one of the calling terminal number and the called terminal number according to the call request; and
judging the call type of a call service corresponding to the call request according to the plan information of the calling terminal number and the called terminal number.

2. The method according to claim 1, wherein the step of querying the number information storage server for the plan information of at least one of the calling terminal number and the called terminal number comprises:
sending a query request that carries the calling terminal number to the number information storage server, and receiving, from the number information storage server, a query response that carries the plan information of the calling terminal number; and/or
sending a query request that carries the called terminal number to the number information storage server, and receiving, from the number information storage server, a query response that carries the plan information of the called terminal number.

3. The method according to claim 1, further comprising:
judging the call type of the call service corresponding to the call request according to the plan information of the calling terminal number, the plan information of the called terminal number, and plan-related information.

4. The method according to claim 3, wherein the step of judging the call type of the call service corresponding to the call request according to the plan information of the calling terminal number, the plan information of the called terminal number, and the plan-related information comprises:
sending a user plan-related request to the number information storage server according to the plan information of the calling terminal number and the called terminal number; and judging the call type of the call service corresponding to the call request according to the plan-related information sent by the number information storage server.

5. The method according to claim 1, wherein the step of judging the call type of the call service corresponding to the call request according to the plan information of the calling terminal number and the called terminal number comprises:
querying, by the number information storage server, for the plan information of the calling terminal number and/or the called terminal number, and
judging the call type of the call service corresponding to the call request according to the plan information of at least one of the calling terminal number and the called terminal number.

6. The method according to claim 5, further comprising:
querying, by the number information storage server, for at least one of the plan information of the calling terminal number and the called terminal number,
querying for the plan-related information according to the plan information of at least one of the calling terminal number and the called terminal number, and
judging the call type of the call service corresponding to the call request according to the plan-related information.

7. The method according to claim 1, wherein if the called terminal number is a preset service number, the step of querying the number information storage server for the plan information of at least one of the calling terminal number and the called terminal number comprises:
querying the number information storage server for the plan information of the calling terminal number;
receiving the plan information of the calling terminal number from the number information storage server, and
generating a plan parameter for the called terminal number according to a planned area represented by the plan information of the calling terminal number and according to preset rules.

8. The method according to claim 7, wherein the step of judging the call type of the call service corresponding to the call request according to the plan information of the calling terminal number and the called terminal number comprises:
determining that the call type of the call service corresponding to the call request is a local call according to the plan information of the calling terminal number and the plan parameter of the called terminal number, so that the calling terminal implements the call service for a local service number.

9. The method according to claim 1, wherein the step of judging the call type of the call service corresponding to the call request according to the plan information of the calling terminal number and the called terminal number comprise:
generating planned domain names of the calling terminal number and the called terminal number according to planned area names corresponding to the plan information of the calling terminal number and the called terminal number;
checking whether a Domain Name System (DNS) that stores a set of local call domain names comprises the planned domain names of the calling terminal number and the called terminal number; and
if the DNS comprises the planned domain names, determining that the calling terminal number and the called terminal number are located in the same local calling area, and receiving a local call type parameter generated by the DNS; if the DNS does not comprise the planned domain names, determining that the calling terminal number and the called terminal number are located in different local calling areas.

10. The method according to claim 1, wherein:
the method is preceded by the step of: storing the plan information of the calling terminal number when the calling terminal registers; and
the step of querying the number information storage server for the plan information of the calling terminal number and/or the called terminal number comprises:
obtaining the locally stored plan information of the calling terminal number; and
querying the number information storage server for the plan information of the called terminal number.

11. The method according to claim 1, wherein after judging the call type of the call service corresponding to the call request according to the plan information of the calling terminal number and the called terminal number, the method further comprises:
storing the plan information of the calling terminal number and the called terminal number;
obtaining the locally stored plan information of the calling terminal number and querying the number information storage server for the plan information of another called terminal number after receiving a call request sent by the calling terminal to said another called terminal; or
obtaining the locally stored plan information of the called terminal number and querying the number information storage server for the plan information of another calling terminal number after receiving a call request sent by said another calling terminal to the called terminal; or
obtaining the locally stored plan information of the calling terminal number and the called terminal number after receiving a call request sent by the calling terminal to the called terminal.

12. A call control server, comprising:
a receiving module, configured to receive a call request from a calling terminal, wherein the call request carries a calling terminal number and a called terminal number;
a first querying module, configured to query a number information storage server for at least one of plan-related information and plan information of the calling terminal number and the called terminal number in the call request received by the receiving module; and
a judging module, configured to judge a call type of a call service corresponding to the call request according to the plan-related information and/or the plan information of the calling terminal number and the called terminal number, wherein the plan information and/or plan-related information is obtained by the first querying module.

13. The call control server according to claim 12, wherein:
the call control server comprises a storing module, configured to store one of the plan information of the calling terminal number when the calling terminal registers; or the plan information of the calling terminal number or the called terminal number, wherein the plan information is obtained by the first querying module; and
the first querying module is further configured to query the storing module for the plan information of the calling terminal number and/or the called terminal number.

14. The call control server according to claim 12, further comprising:
a generating module, configured to generate planned domain names of the calling terminal number and the called terminal number according to planned area names corresponding to the plan information of the calling terminal number and the called terminal number, wherein the plan information is obtained by the first querying module; and
a second querying module, configured to check whether a Domain Name System (DNS) that stores a set of local call domain names comprises the planned domain names of the calling terminal number and the called terminal number, wherein the planned domain names are generated by the generating module.

15. The call control server according to claim 12, wherein:
the judging module is further configured to judge the call type of the call service corresponding to the call request, according to the plan information of the calling terminal number and the called terminal number and the plan-related information, wherein the plan information and the plan-related information are obtained by the first querying module.

16. A number information storage server, comprising:
a storing module, configured to store at least one of plan information and plan-related information of a number;
a receiving module, configured to receive a message for querying for plan information of a calling terminal number and/or a called terminal number;
a querying module, configured to query one of:
the storing module for the plan information of the calling terminal number or the called terminal number according to the message received by the receiving module;
or the storing module for the plan-related information according to the plan information of the calling terminal number and/or the called terminal number; and
a sending module, configured to send at least one of:
the plan information of the calling terminal number and the called terminal number, and send the plan-related information, wherein the plan information and the plan-related information are obtained by the querying module.

17. The number information storage server according to claim 16, further comprising:
a judging module, configured to judge a call type of a call service corresponding to at least one of the call request according to the plan information of the calling terminal number and the called terminal number and the plan-related information, wherein the plan information and the plan-related information are obtained by the querying module.

18. The number information storage server according to claim 16, further comprising:
a generating module, configured to generate a plan parameter of the called terminal number according to the plan information of the calling terminal number when the called terminal number is a preset service number;
the sending module, configured to send the plan parameter of the called terminal number to a call control server.

19. The number information storage server according to claim 16, further comprising:
an updating module, configured to update the plan information of the number stored in the storing module according to a routing update guide file.

20. The number information storage server according to claim 16, wherein the number information storage server is:
a single number information storage server, or a number information storage server pool including more than one number information storage server.
